(19) United States
(12) Patent Application Publication
(10) Pub. No.: US 2003/0123410 A1
(43) Pub. Date: Jul. 3, 2003

(54) Compensating forward link speed

(75) Inventor: Jee Woon Youm, Anyang-si (KR)

Correspondence Address: FLESHNER & KIM, LLP, P.O. Box 221200, Chantilly, VA, 20153-1200, US

(73) Assignee: LG Electronics Inc.

(21) Appl. No.: 10/322,629

(22) Filed: Dec. 19, 2002

(30) Foreign Application Priority Data
Dec. 28, 2001 (KR) 87465/2001

(51) Int. Cl. H04B 7/216; H04B 7/212

(52) U.S. Cl. 370/335; 370/337

(57) ABSTRACT

Embodiments to the present invention relate to a method that comprises receiving a data frame having a plurality of slots. A number of time slots of the plurality time slots are designated to a communication channel is according to a maximum data rate of the communication channel and the required data rate of the communication channel.

### BACKGROUND OF THE INVENTION

1. Field of the Invention

The present invention relates to at least one of electronics and communications.

2. Background of the Related Art

Mobile radio communication systems are used in everyday life. Garage door openers, remote controllers for home entertainment equipment, cordless telephones, hand-held walkie-talkies, pagers, and cellular telephones are all examples of mobile radio communication systems. For example, cellular radio systems provide high quality service that is often comparable to that of landline telephone system.

### SUMMARY OF THE INVENTION

Embodiments to the present invention relate to a method that comprises receiving a data frame having a plurality of slots. A number of time slots of the plurality time slots are designated to a communication channel is according to a maximum data rate of the communication channel and the required data rate of the communication channel.

In wireless communications, communication between a cellular telephone and a base station may be transmitted only at designated times. This arrangement is advantageous, as a plurality of cellular telephones can communicate with a single base station. During the designated times for communication between a given cellular telephone and a base station, the communication may be conducted at a maximum data rate of a communication channel between the cellular telephone and the base station. This maximum data rate of a communication channel may be related to the physical distance between cellular telephone and the base station. However other factors may determine this maximum data rate (e.g. slower communication may be a result of a cellular telephone being inside a building with thick walls). In order to compensate for a low maximum data rate of a communication channel, embodiments of the present invention can vary the number of time slots over which a communication channel communicates. This in advantageous, as a user of a cellular telephone may be able to maintain the same integrity of service regardless of how low a maximum data rate of the communication channel is at a given point in time.

### BRIEF DESCRIPTION OF THE DRAWINGS

FIG. 1 is an exemplary structural view of CDMA cellular communication network.

FIG. 2 is an exemplary forward channel structure of 1×EV-DO.

FIG. 3 is an exemplary reverse channel structure of 1×EV-DO.

FIG. 4 is an exemplary structural view of forward time slot of 1×EV-DO.

FIG. 5 is an exemplary table representing modulation parameter for a forward link of 1×EV-DO.

FIG. 6 is an exemplary table representing output characteristics of 1×EV-DO.

FIG. 7 is an exemplary flowchart representing a scheduling method for forward link speed of 1×EV-DO.

FIG. 8 is a drawing representing examples for data assignment of slots for each subscriber by a scheduling method for forward link of 1×EV-DO.

FIG. 9 is an exemplary structural view of a mobile station and a base station in 1×EV-DO.

FIG. 10 is an exemplary flowchart representing a scheduling method for a forward link in 1×EV-DO.

FIG. 11 is an exemplary table representing a weighted value table upon scheduling a forward direction in 1×EV-DO.

FIG. 12 is a drawing representing examples for applying weighted values to each subscriber on the basis of a weighted value table upon scheduling for a forward direction in 1×EV-DO.

### DETAILED DESCRIPTION OF PREFERRED EMBODIMENTS

A high speed data transmitting system (1×EV-DO:1×) may be referred to as HDR (High Data Rate) or 1×EV-DO. HDR is a wireless data technology which may be for providing data transmitting speeds of 2.4 Mbps on a CDMA standard voice channel at 1.25 Mhz. HDR may be used for improving a data transmitting ability on an existing CDMA system.

In an existing CDMA network, part of channels may be changed from a voice channel into a data channel. HDR may use a combination of TDM rime Division Multiplexing) and CDMA (Code Division Multiple Access) so that many users may share each channel. HDR may not have a fixed time band as the case of TDMA (Time Division Multiple Access). HDR may use a time band only when necessary.

A 1×EV-DO wireless data communication network may provide multimedia service from an existing communication service oriented to voice service. Multimedia service may be part of a high speed packet data service, guaranteed continuity in communication. A guaranteed continuity in communication may be provided without communication path cut off even if a user moves from a present cell to an adjacent cell in the same system during conversation. A data speed of HDR may be optimized for IP (Internet Protocol) packets and Internet access. A data speed may be varied depending on the distance between a mobile phone and a base station.

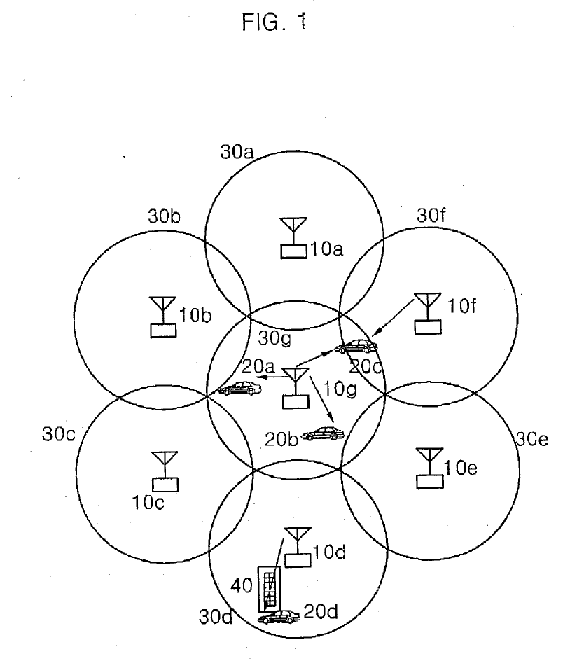

FIG. 1 is an exemplary illustration of a cellular communication network including a plurality of cells. Referring to FIG. 1, each cell 30a-30g may be serviced by corresponding base stations 10a˜10g. A variety of mobile stations 20a-20d within a CDMA network may communicate with one or more cells, which may be determined by whether a mobile station has a soft hand-off status. For example, specific mobile stations 20a, 20b may communicate with base station 10g. However mobile station 20c (adjacent to borders of cells 30f, 30g) may have a soft hand-off status and therefore communication with two base stations 10f, 10g. In a circumstance that a user on a border region moves into another cell in a CDMA system, a user may move into another cell without conversation cut off due to a soft hand-off. In a case that mobile station 20d is in a shadow region due to building 40 (or another geographic features), mobile station 20d may request a different DRC (Data Rate Control) value due to a degradation of a communication environment. In a CDMA cellular communication network, a base station may interface with all base stations of a packet network interface or a PSTN (Public Switched Telephone Network) CDMA network through a senior base station controller, to interface with all subscribers.

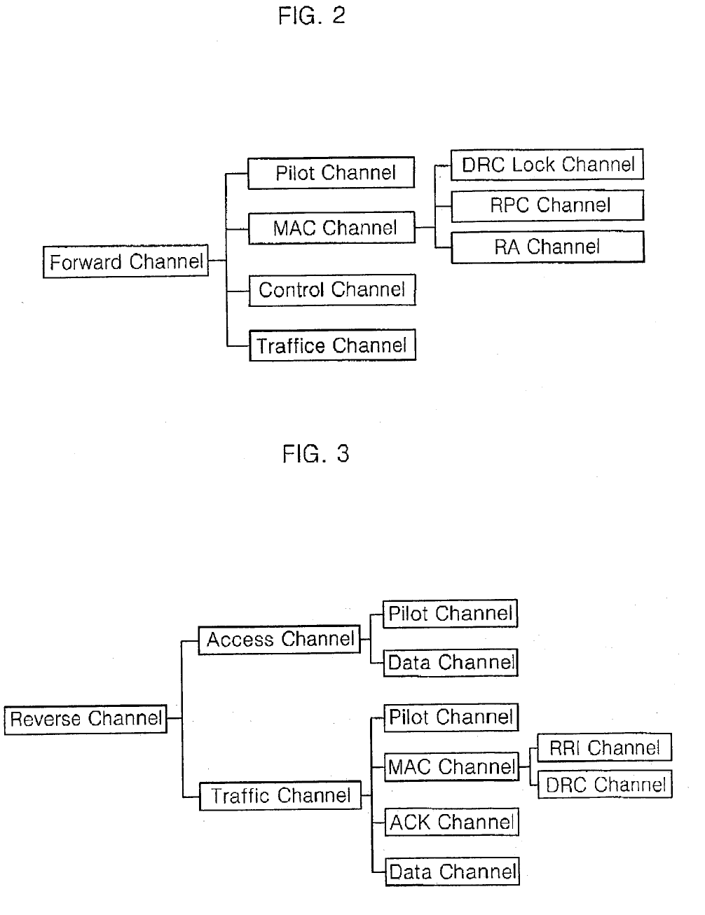

Exemplary FIG. 2 and FIG. 3 illustrate channel structures on a forward direction and a reverse direction for 1×EV-DO. A physical layer of 1×EV-DO may be divided into a forward channel from a base station to a mobile station and a reverse channel from the mobile station to the base station. A plurality of physical channels may also exist.

Referring to FIG. 2, a structure on a forward direction for a 1×EV-DO may be divided into a pilot channel, a MAC channel (Medium Access Control Channel), a control channel, and a traffic channel. A pilot channel may be used as a standard channel for detecting coherency of an access terminal (e.g. as in IS-2000). A MAC channel may be used for controlling transmitting speed. A control channel may be used for transmitting control information for a call process. A MAC channel, unlike a media access control layer, may be a channel existing on a physical layer. A MAC channel may be divided into a RA (Reverse Activity) channel, a RPC (Reverse Power Control) channel, and/or a DRC lock channel. In a forward direction, all physical channels may be transmitted on one single channel. In TDM, channels may be separated in time used, so that a plurality of channels may be divided in a time-division manner and signals may be physically spread.

FIG. 3 is an exemplary illustration of a reverse channel. A reverse channel may be divided into an access channel and a traffic channel. Both a reverse channel and an access channel may be transmitted simultaneously with a pilot channel of a base station. A traffic channel may be divided into a pilot channel, a MAC channel, an ACK channel (Acknowledgement Channel), and/or a data channel. A MAC channel may be for transmitting information on whether a packet of a physical layer is received normally. An access channel may be connected in a random access manner, with information defined by a MAC (Medium Access Control) layer. A pilot channel may be formed on a physical layer and may include a signal not modulated by a 16-Walsh function. A RRI (Reverse Rate Indicator) of a MAC channel may be a channel for informing a base station of a reverse direction transmitting speed. A DRC channel may be used for requesting a desired transmitting speed from a base station.

CDMA2000-1x may accommodate many subscribers using energy of a traffic channel. Actual data may be from whole energy and may adopt an energy adjusting method of a traffic channel for power control. 1×EV-DO may use energy of a fixed traffic channel, preparing a constant time slot for each subscriber. 1×EV-DO may assign a transmitting speed, using a modulating method fit for traffic of each subscriber. 1×EV-DO may use TDM (Time division Multiplexing).

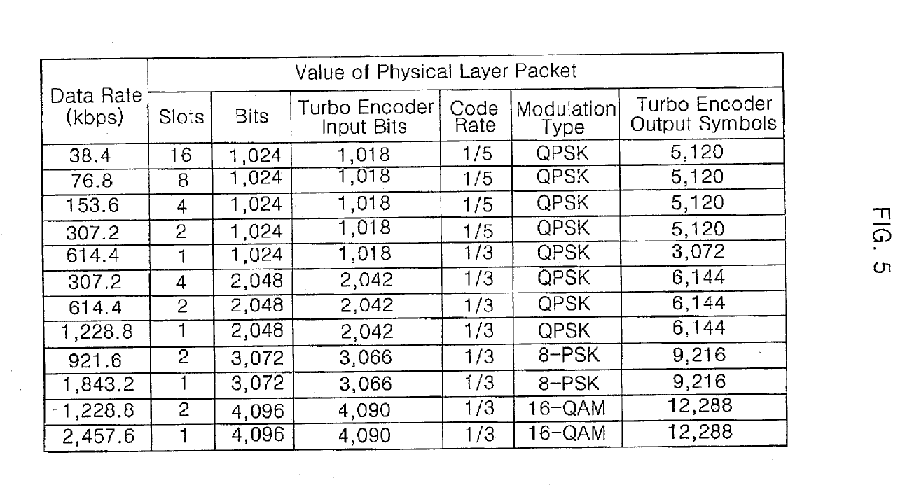

FIG. 5 is an exemplary illustration of forward transmitting speed in 1×EV-DO. Forward transmitting speed may be 2.4576 Mbps. Transmitting speed in a reverse direction may be from 9.6 Kbps to 153 Kbps. Accordingly, 1×EV-DO may have an asymmetric structure in a forward direction and a reverse direction, with emphasis placed on downloading from a network. Power control of a mobile station may be transmitted by a unit of 600 Hz. In IS-95, power control of a mobile station may be transmitted by a unit of 800Hz. Control of a transmitting speed may play an important role. For example in IS-2000, a forward channel may include a pilot channel, a synchronization channel substantially fixed at a predetermined energy level. A traffic channel may be variable in accordance with energy of a paging channel. In 1×EV-DO, a forward channel may include a pilot channel and a control channel periodic in time at a fixed whole energy level. A time slot may be dynamically assigned depending on distribution of subscribers and radio propagation circumstances.

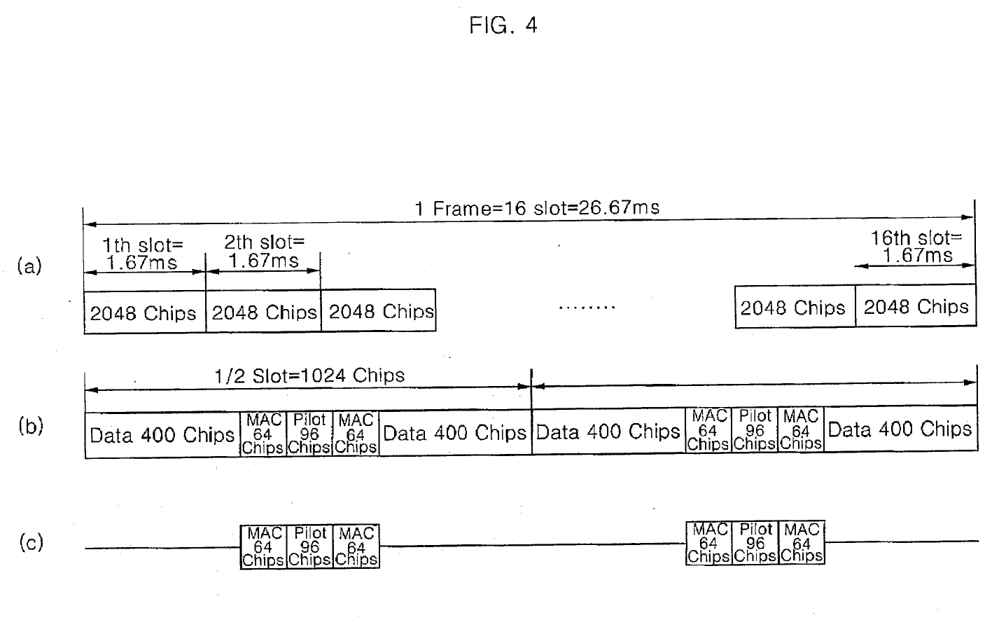

FIG. 4 is an exemplary illustration of a slot structure of a forward channel for 1×EV-DO. FIG. 4(a) illustrates, a slot structure of a forward channel that may include one frame having 16 slots (e.g. 16 slots=26.67 ms). Each slot may form two half slots (½ slot =1024chips) forming 1.67 ms (2048chips). A half slot may be a minimum unit for containing substantial information.

A slot structure of a forward channel (e.g. in a case that user data is transmitted (activity slot)) may be transmitted in sequence of a data channel (e.g. 400chips), a MAC channel, (e.g. 64chips), a pilot channel (e.g. 96chips), a MAC channel and a data channel. Transmission may be made by a unit of a half slot, as illustrated in FIG. 4(b). If data is not present (idle slot), only a MAC channel and a pilot channel, may be transmitted as shown in FIG. 4(C). In a half slot, a pilot channel, a MAC channel, and/or a data channel (a control channel or a traffic channel) may be transmitted in TDM.

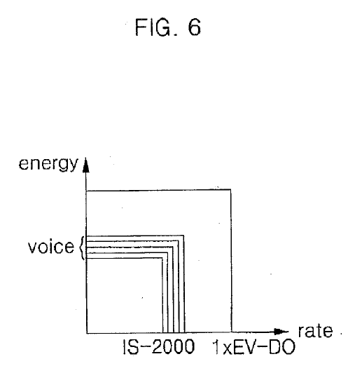

FIG. 5 is an exemplary table representing exemplary values on a packet of a physical layer in a forward direction according to a date rate of 1×EV-DO. A packet format in a forward direction may be transmitted by unit of 26.67 ms (16slots) and may use 1,2,4,8,16 slots depending on a transmission rate. For example, if a data rate of 153.6 Kbps is assigned, a turbo code rate may become ⅕. QPSK (Quadrature Phase Shift Keying) may be used for modulation. Namely, a turbo code rate and/or a modulation method may be varied according to an assigned data rate. For determination of a forward speed for 1×EV-DO, a mobile station AT may measure C/I (Catrier to Interference) of a received pilot signal by unit of every packet. A mobile station AT may transmit a DRC fit for that signal. A base station may determine an optimum data transmitting speed by which data is transmitted to 9 mobile station. Exemplary processing amounts in 1×EV-DO and IS-2000 systems are represented by FIG. 6A IS-2000 system may be an indispensable power control for optimizing system capacity (subscriber accommodating capacity in a wireless section), as voice is transmitted in a form of circuit data. A 1×EV-DO system may be used for packet data. 1×EV-DO may be used for controlling system capacity through a transmission speed for each subscriber using fixed energy level between wireless sections.

When transmission speed is high in a wireless section, probability for error generation is high. Accordingly, relatively high power may be required in order to guarantee a desired QoS (Quality of Service). In high speed transmission, accommodating capacity for subscriber on wireless section may decrease. In IS-2000, energy distribution in a wireless section may be formed depending on voice activity of a subscriber during conversation. In 1×EV-DO, maximum energy may be exerted and a mobile station may be assigned a time slot of one section in time. For example, in a 1×EV-DO, a pilot channel, a MAC channel, a control channel, which may be overhead information, may occupy a periodic time slot. Remaining time slots may be used for a traffic channel of a user. Even in a traffic channel, subscribers of telephone traffic may use many slots, while subscribers of small telephone traffic may use relatively small time slots, thereby occupying a time slot for a short period of time.

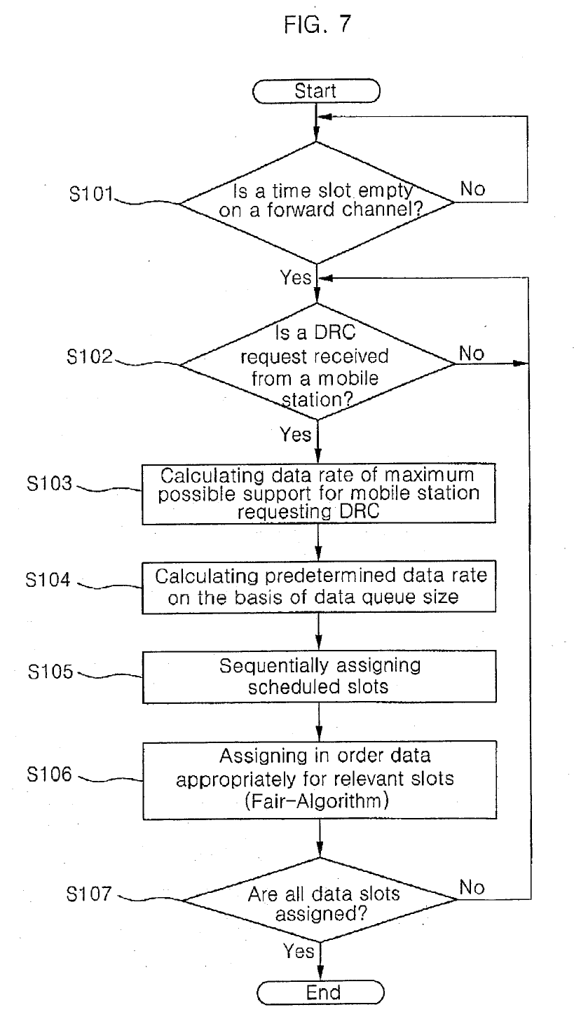

FIG. 7 is an exemplary flowchart illustrating a scheduling method for forward link speed of a 1×EV-DO system. A channel scheduler of a base station may collect all the related information necessary for optimally distributing resources for each scheduled subscriber, assigning a data transmission rate to each scheduled subscriber. A channel scheduler may check if a time slot of a forward channel is empty (S101). A channel scheduler may determine if a DRC request is received from a mobile station in a case that a time slot of a forward channel is empty (S102).

A DRC request may be received from a mobile station. If a cell within an active member is set for a high speed data transmission, then selecting a minimum transmission rate from a transmission rate list of maximum possible support for a scheduled user. As a minimum transmission rate selected in this manner is transmitted as a maximum transmission rate for a scheduled user, a data rate of a maximum possible support may be calculated for a mobile station requesting DRC (S103).

Checking a queue size of data to determine an amount of data that is to be transmitted to a scheduled user, given a predetermined data rate command for queue size. A predetermined transmission rate may be equal to or smaller than a minimum transmission rate necessary for data transmission within a scheduled section. Calculation of a predetermined data rate may be made on a basis of a data queue size (S104). A scheduled slot may be sequentially assigned (S105). Data may be divided that would be sent to a scheduled slot, ordering data appropriately for a relevant slot (S106).

After checking of whether subscriber data is to be sent to all assigned slots (S107), step S102 is implemented if the subscriber data is not all assigned. Receiving a DRC request, calculating data rate, then performing assigning by one slot unit till all data that is to be sent are assigned to a scheduled slot, may be parts of assigning data (S107). A scheduling period may sequentially assign data to be sent by one slot unit using a fair algorithm, transmitting, by packet unit, a time slot on which data is assigned, to at least more than one subscriber.

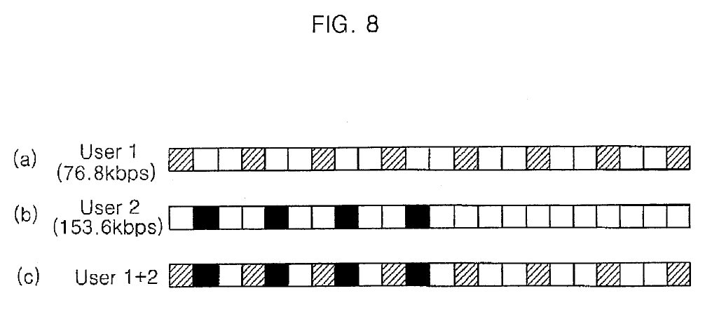

FIG. 8 shows an exemplary illustration of an output scheduled by a channel scheduler of a base station 200 upon different DRC requests (e.g. user 1=76.8 Kbps, user 2=153.6 Kbps) by two subscribers. If two subscribers request a same amount of data and DRC requests for each subscriber are different (e.g. a DRC request for subscriber 1 is 76.8 Kbps and a DRC request for subscriber 2 is 153.6 Kbps), the number of slots according to a DRC shows two times difference. Accordingly, subscriber 1 may receive data at a lower speed than subscriber 2 as a result of scheduling (e.g. time necessary for reception of data by scheduling is two times longer).

For example, in a case that two subscribers request the same data, as shown in exemplary FIG. 8(a), subscriber 1 may request 76.8 Kbps, so that 8 slots scheduled not to be overlapped on other subscribers, is assigned to subscriber 1, as shown in exemplary FIG. 8(b). Subscriber 2 may request 153.6 Kbps, so that 4 slots scheduled, not to be overlapped on other subscribers, is assigned to subscriber 2. Upon assignment of slots, slots assigned with constant interval or the slots may overlap on other subscribers slots. Exemplary FIG. 8(c) illustrates packet data of two subscribers, other subscribers are divided into time slots and transmitted. Exemplary FIG. 8(c) illustrates packet data sent to two subscribers, put on a bearer, transmitted to each mobile station, so that subscriber 1 may receive all data only if 8 slots on which data is assigned, is received. Subscriber 2 may receive all data only if 4 slots on which data is assigned, is received.

In a wireless data communication network discussed above, if a subscriber moves into a region where receiver sensitivity is low, a mobile station may analyzes a pilot signal of a base station, calculate low C/I, and transmit a DRC signal of a relatively low speed as a reverse signal, to an optimum base station as a result of the calculation. A base station may receive a DRC signal (request) for determining a forward link speed and performing scheduling for transmitting to a subscriber. Data service speed by which a subscriber receives, may drop down to the dissatisfaction of a subscriber.

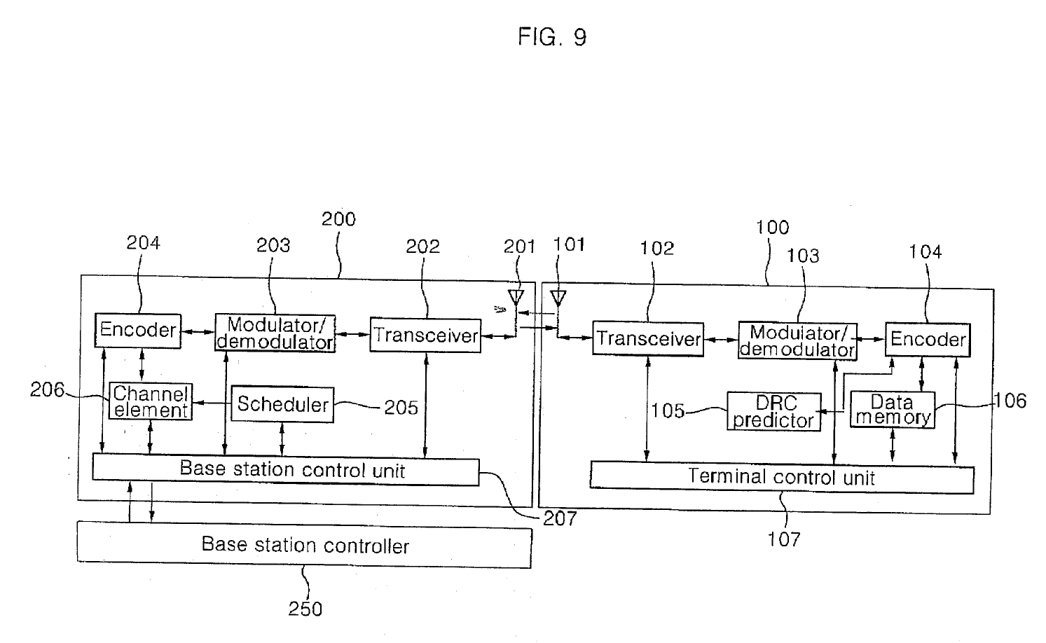

FIG. 9 an exemplary structural view of a mobile station and a base station in a 1×EV-DO system according to embodiments of the present invention. Mobile station 100 may include transceiver 102, modulator/demodulator 103, encoder 104, DRC (Data Rate Control) predictor 105, data memory 106, terminal control unit 107, and/or could be connected to a notebook or used independently so that a user may directly receive data service. Transceiver 102 may transmit and receive a wireless data signal to and from base station 200 through antenna 101. Modulator/demodulator 103 may spread data that would be transmitted into a CDMA signal of a predetermined band and may make a data signal by inversely spreading a transmitted/received CDMA signal. Encoder 104 may play a role of decoding and encoding data. DRC predictor 105 may measure C/I (Carrier Interference) of a pilot signal received from a base station by a packet unit and may inform base station 200 of an appropriate DRC value. Base station 200 may determine an optimum data transmission speed for mobile station 100.

Mobile station 100 may be arranged dispersedly all over a data communication system, communicating with zero or one base station 200 upon forward linking. A base station may include transceiver 202, modulator/demodulator 203, encoder 204, scheduler 205, channel element 206, base station control unit 207, and/or may be under control of senior base station controller 250. Transceiver 202 may receive and filter a CDMA signal transmitted from mobile station 100. Transceiver 202 may perform low noise-amplifying. Transceiver 202 may perform down converting of a filtered CDMA signal into an IF (Intermediate Frequency) signal. Transceiver 202 may transfer a signal to modulator/demodulator 203, while amplifying and filtering a CDMA signal that would be sent to mobile station 100. Transceiver 202 may radiate a filtered CDMA signal to the outside through antenna 201. Modulator/demodulator 203 may spread data that would be transmitted into a CDMA signal of a predetermined band and/or make a data signal by inversely spreading a received CDMA signal. Decoder 204 may perform decoding and encoding of data.

Scheduler 205 may have has a scheduling period. Scheduler 205 may collect related information from all cells. Scheduler 205 may schedule a high speed data transmission. Scheduler 205 may distribute resources to scheduled subscribers. Scheduler 205 may determine a data rate that would be transmitted to each mobile station 100 on the basis of a DRC value. Scheduler 205 may determine whether to apply a weighted value with reference to a weighted value table if the data rate is determined. Scheduler 205 may sequentially assign a unit slot or a plurality of slots discriminately according to determination results. Scheduler 205 may put data onto an assigned slot. Channel element 206 may put data on a relevant channel. Channel element 206 may transmit data in response to scheduler 205. Base station control unit 207 communicate with senior base station controller APC 250 and may control operations of each unit.

In embodiments of the present invention, scheduler 205 selectively perform unit slot assignment or assignment of a plurality of slots according to a determined data rate for forward link data transmission of base station 200. Scheduler 205 may determine whether to apply a weighted value with reference to a weighted value table according to a data rate. Scheduler 205 may be connected to a channel queue and channel element 206 of a base station. Schedular 205 may receive a queue size. A queue size may represent a data amount that would be transmitted to mobile station 100 and a DRC message of a mobile station. Scheduler 205 may perform scheduling for high speed data transmission so that purposes of a system, which are a maximum data process ability and a minimum transmission delay, may be optimized.

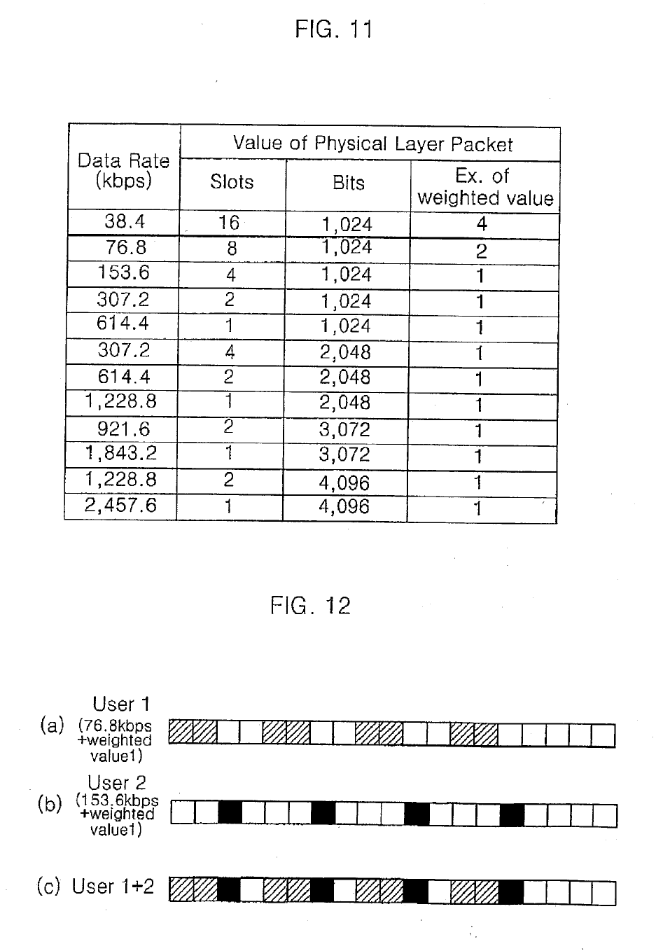

Mobile station 100 may check strength of a pilot signal of a base station through antenna 101. A strength of a pilot signal may represent the pilot signal as a ratio of C/I while moving. With such C/I ratio, mobile station 100 may provide a DRC value that would be sent to base station 200 through DRC predictor 105 installed within a mobile station. Upon receipt of a DRC value at a base station, scheduler 205 of base station 200 may determine a data rate that would be sent to each mobile station 100 on the basis of the DRC value. Scheduler 205 may determine whether to apply a weighted value according to a data rate referring to a weighted value table. FIG. 11 illustrates an exemplary weighted value table Scheduler 205 may put data on a predetermined slot. Whether to apply a weighted value table, may be determined by a service provider. Determination criterion for a weighted value table may be determined by receive sensitivity of a subscriber.

Base station controller 250 may transmit data in form of a data frame to a base station. A data frame may represent a data amount that is transmitted from base station 200 to mobile station 100 during one frame time. If data transmission occurs on a plurality of code channels, a data frame may be further divided into data and encoded. Data frames may be sent to the channel element 206. Channel elements 206 may make a format out of data frames. Channel element 206 may insert a set of CRC bits and a set of code tail bits generated. Channel element 206 may make a convolution code out of data. Channel element 206 may interleave encoded data. Channel elements 206 may spread interleaved data using a long PN (Pseudo Noise) code, a walsh code, and/or a short PN code.

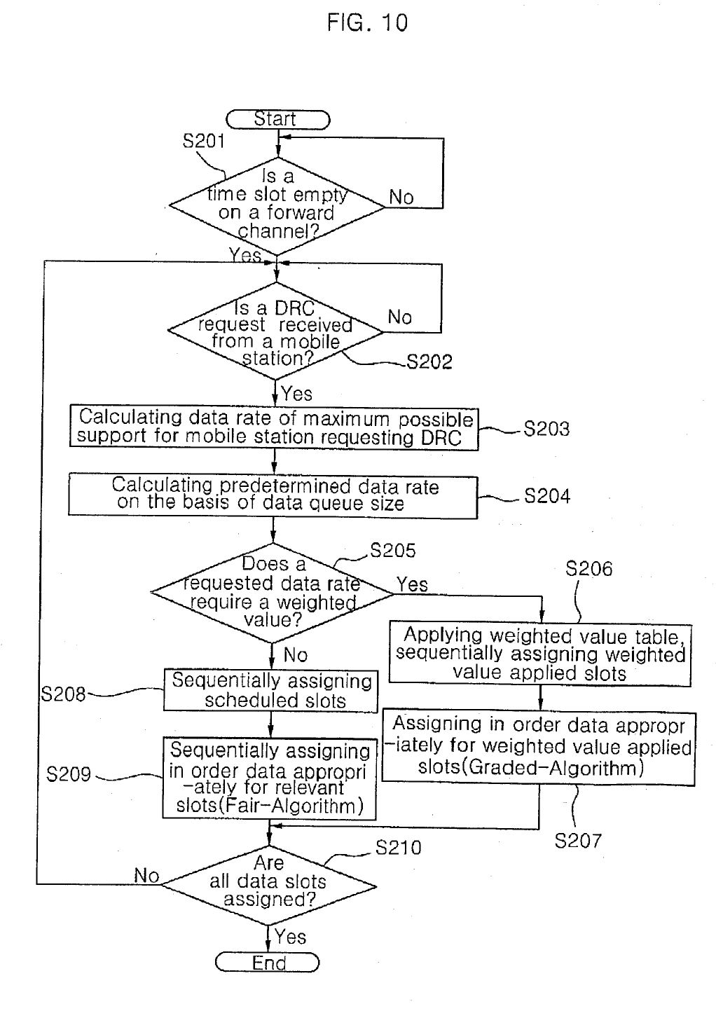

Embodiments of the present invention relating to a scheduling method for compensating forward link speed, are illustrated in FIG. 10 through FIG. 12. It may be checked if a time slot on a forward channel is empty (S201). It may be determined whether a DRC request is received from a mobile station if a time slot on a forward channel is empty (S202). If a DRC request is received from a mobile station, a rate of a maximum possible support may be calculated for a scheduled subscriber with respect to each mobile station requesting DRC (S203). A transmission rate of maximum possible support may be calculated by dividing the entire residual power available for a selected cell by energy per bit necessary for a subscriber.

A data amount that would be transmitted to a scheduled subscriber may be determined on a basis of a data queue size. Calculating a predetermined rate for a queue size and/or giving a command (S204). A predetermined rate may be equal to or smaller than a minimum rate necessary for data transmission within a scheduling section. Determining whether to apply a weighted value with respect to a requested data rate may be performed. In embodiments, a weighted value may be determined with reference to weighted value table (S205). FIG. 11 illustrates embodiments that sequentially assign a weighted value applied time slot according to a value on a weighted value table if a weighted value is applied as a result of a determination (S206). Assigning data in order appropriately for a weighted value applied slot may be performed (S207). It may be determined if data to be sent are all assigned to a slot (S210). Terminating, if data are all assigned to a slot, may be performed. Performing and repeating step S202 may be performed until all data that is to be sent are all assigned.

In a case that a weighted value for a requested data rate is not necessary, (e.g. in a case of a data rate of more than a predetermined speed), sequentially assigning a scheduled slot (S208). Assigning in order data appropriately for a relevant time slot (S209). Determining if data to be transmitted are all assigned to a slot (S210). Terminating scheduling procedure if data that is to be transmitted are all assigned to a slot, may be performed while performing step S202, if data that would be transmitted are not all assigned to a slot.

In embodiments, a scheduling method by a scheduler, may perform slot assignments that are carried out discriminately according to receive sensitivity of a subscriber. In embodiments, transmission speed compensation for a subscriber of a relatively low data rate, may be made through unit slot assignment and assignment for a plurality of slots with application of a weighted value. A unit slot assignment may assign one time slot at a time. A unit slot assignment may indiscriminately assign a scheduled slot in a general way in a case of more than a predetermined speed (for example, 153.6 Kbps), with a weighted value being 1. Assignment for a plurality of slots may assign a plurality of time slots at a time by applying discriminative weight values for data rates of less than a specific speed (for example, 76.8 Kbps). For example, in a case that 76.8 Kbps is a specific speed, a weighted value of 2 may be applied to a relevant data rate. Accordingly twice the number of time slots may be assigned and data may be sent sequentially assigned to doubled time slots. As another example, for a data rate of 38.4 Kbps, a weighted value may be 4 and assignment is made by unit of four slots at a time and data be is sent sequentially assigned to four slots.

In embodiments, for different DRC requests from at least two subscribers, discriminative slot assignment may be applied. Accordingly transmissions may be made so that data is received for a same time period with respect to same data. In embodiments, for a scheduler, scheduling periods for a unit slot assignment and an assignment for a plurality of slots maybe the same.

FIG. 11, is an example of a weighted value table according to data rate. A weighted value for a data rate of more than a predetermined speed (e.g. 153.6 Kbps˜2,457.6 Kbps) may be 1. Accordingly, an assignment may be performed by a unit slot. Weighted values from a specific data rate of less than a predetermined speed (e.g. 76.8 Kbps) to the lowest data rate (e.g. 38.4 Kbps), may have values increased by two times discriminatively. For example, for a specific data rate of 76.8 Kbps, whose weighted value is 2, assignment may be performed by unit of two time slots upon one time of scheduling. A data rate of 38.6 Kbps, whose weighted value is 4, may be assigned by unit of four time slots upon one time of scheduling. A weighted value applied to a specific data rate of less than a predetermined speed may be proportional to a number of time slots assigned during one time of scheduling period and may be inversely proportional to the data rate. In embodiments, a service provider may determine a weighted value for a lower requested data rate and may assign time slots on that data rate.

Subscribers may request different DRCs. Service providers may apply a weighted value so that subscribers can receive data quickly regardless of data rate. As exemplified in FIG. 12, subscriber 1 may request 76.8 Kbps and subscriber 2 may request 153.6 Kbps. A number of slots according to DRCs may show two time-differences. Scheduled results may be twice the time slots assigned to a DRC slot for subscriber 1. Accordingly subscriber 1 and subscriber 2 may receive service of substantially the same quality.

As an example, in a case that different subscribers request different DRCs (User 1:76.8 Kbps, User 2:153.6 Kbps), twice as many time slots as existing time slots may be assigned if a weighted value on a weighted value table is “2” (as exemplified in (a) of FIG. 12). Accordingly, a relatively high transmission speed may be supported for subscriber 1 (the user 1) of a relatively low DRC request. A weighted value may not be applied to subscriber 2 (the user 2) of a data rate of more than a predetermined speed (as exemplified in (b) of FIG. 12). As illustrated in (c) of FIG. 12, subscriber slots on a wireless bearer may not overlap and be transmitted as one single packet. Subscriber 1 may receive eight slots in a shorter time, while experiencing the same quality of service as subscriber 2. As another example, in a case of a weighted value of “4”, that weighted value may be at least inversely proportional to data rates of the two subscribers. Accordingly, four slots may be assigned during one scheduling period, whereby service of the same quality could be experienced.

Upon scheduling, a scheduler may apply both unit slot assignment and assignment for a plurality of slots. Weighted values for a basic unit and a plural unit may be varied depending on where a critical value of a unit slot is set. Condition may be different depending on wireless communication circumstances and resources. In a scheduling method for a forward link according to embodiments of the present invention, a weighted value for forward date rates of less than a predetermined speed may be applied if propagation circumstance of a subscriber is poor. Assigning time slots as many as that weighted value, thereby guaranteeing service of more than a predetermined level, may achieve a desired QoS (Quality of Service). In embodiments of the present invention, a service provider may control a high speed data service of more than a predetermined level, to a subscriber even in a case that receiver sensitivity is low.

One object of embodiments of the present invention is to provide a method and an apparatus for scheduling a forward link speed compensation by applying a weighted value to a forward data rate of less than a predetermined speed, assigning time slots as many as necessary, in order to provide a high speed data service of more than a predetermined level, to a subscriber even in case that receive sensitivity of the subscriber is low.

An object of embodiments of the present invention is to provide a method and an apparatus for scheduling a forward link speed compensation, capable of determining whether to apply a weighted value with reference to a weighted value table according to a determined data rate with respect to a DRC (Data Rate Control) request received from at least one mobile station, selectively performing unit slot assignment or assignment of a plurality of slots according to determination results.

An object of embodiments of the invention is to provide a method and an apparatus for scheduling a forward link speed compensation, capable of defining a weighted value between adjacent data rates as an increased value by two times, from a specific data rate to the lowest data rate that fall on application object for the weighted value, assigning a plurality of slots accordingly. An object of embodiments of the invention is to provide a method and an apparatus for scheduling a forward link speed compensation, wherein a service provider could determine whether to apply the weighted value table. An object of embodiments of the invention is to provide a method and an apparatus for scheduling a forward link speed compensation, capable of providing a service of the same quality upon request of the same data amount from mobile stations requesting different DRCs.

Embodiments comprise providing a method for scheduling data transmission on a forward link in a communication network including at least one cell or at least one scheduled subscriber, the method including the steps of: receiving a DRC (Date Rate Control) request from at least one mobile station; calculating data rate of maximum possible support with respect to at least one mobile station requesting the DRC, calculating a predetermined data rate on the basis of a data queue size; determining whether to apply a weighted value according to the requested data rate, then compensating for a transmission speed of a subscriber of a relatively low data rate by applying the weighted value to a data rate of less than a predetermined speed.

In embodiments, the compensating step for a transmission speed includes the steps of: determining whether to apply the weighted value according to the requested data rate with reference to a weighted value table; if the data rate falls on a data rate of less than a predetermined speed as a result of the determination, applying the weighted value table, sequentially assigning slots corresponding to a set weighted value, to that data rate, assigning in order the data appropriately for the assigned slots; and if the data rate falls on a data rate of more than a predetermined speed, sequentially assigning scheduled slots, assigning in order the data appropriately for the relevant slots.

In embodiments, for the weighted value, in case that at least two subscribers request different DRCs, a slot to which the weighted value is applied, is assigned to a subscriber of a relatively low data rate on the basis of the subscribers' data rates.

In embodiments, for the weighted value, in case that at least two subscribers request different DRCs with respect to the same data amount, different weight values are applied on the basis of each data rate.

In embodiments, the weighted value is proportional to the number of slots assigned to one time of slot assignment period, from a specific data rate of less than a predetermined level to the lowest data rate that fall on application object for the weighted value.

In embodiments, if at least two subscribers request the same data with different DRCs, a relatively high weighted value is applied to a relatively low subscriber according to data rates of the two subscribers, so that services of the same quality are provided to the subscribers.

In embodiments, the weighted value table includes: an unit slot weighted value for assigning a slot by one on a data rate from a specific data rate of more than predetermined level among a first data rate and an nth data rate; and a discriminative slot weighted value for increasing a weighted value for data rates from a specific data rate by a multiple of two, assigning the weighted value on the data rates, respectively.

In embodiments, scheduling periods for assigning the unit slot and a plurality of the slots are the same.

Embodiments of the present invention relate to apparatus for scheduling data transmission on a forward link in a communication network including at least one cell or at least one scheduled subscriber, the apparatus includes: a means for calculating a predetermined data rate according to a DRC (Data Rate Control) request received from at least one mobile station; and a scheduler for determining whether to apply a weighted value according to the received data rate, then performing scheduling using a means for performing unit slot assignment or assignment for a plurality of slots according to the determination results.

In embodiments, the scheduler assigns a plurality of slots in one scheduling period by applying different weighted values for data rates of less than a predetermined level referring to the weighted value table.

In embodiments, the scheduler has the same scheduling period for the unit slot assignment and the assignment for a plurality of the slots.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method comprising:
receiving a data frame having a plurality of time slots, wherein:
a number of time slots of the plurality of time slots designated to a communication channel is according to a maximum data rate of the communication channel and the required data rate of the communication channel.

2. The method of claim 1, wherein the maximum data rate of the communication channel is a number of bits that can be received on the communication channel per unit of time.

3. The method of claim 1, wherein the required data rate of the communication channel is a number of bits that are arbitrarily required to be received in each data frame.

4. The method of claim 1, wherein the method is implemented in a wireless device.

5. The method of claim 4, wherein the wireless device is a cellular telephone handset.

6. The method of claim 1, wherein a total number of time slots in the data frame is fixed in all data frames that carry the communication channel.

7. The method of claim 1, wherein the number of time slots designated to the communication channel is varied according to a change in the maximum data rate of the communication channel.

8. The method of claim 1, wherein the required data rate of the communication channel is fixed.

9. A method comprising transmitting a communication channel comprising:
determining a maximum data rate of the communication channel;
determining a required data rate if the communication channel;
designating a number of time slots of a data frame to the communication channel according to the maximum data rate and the required data rate.

10. The method of claim 9, wherein the maximum data rate of the communication channel is a number of bits that can be received on the communication channel per unit of time.

11. The method of claim 9, wherein the required data rate of the communication channel is a number of bits that are arbitrarily required to be received in each data frame.

12. The method of claim 9, wherein the method is implemented in a wireless device.

13. The method of claim 12, wherein the wireless device is a cellular telephone handset.

14. The method of claim 9, wherein a total number of time slots in the data frame is fixed in all data frames that carry the communication channel.

15. The method of claim 9, wherein the number of time slots designated to the communication channel is varied according to a change in the maximum data rate of the communication channel.

16. The method of claim 9, wherein the required data rate of the communication channel is fixed.

17. An apparatus configured to:
receive a data frame having a plurality of time slots, wherein:
a number of time slots of the plurality of time slots designated to a communication channel is according to a maximum data rate of the communication channel and the required data rate of the communication channel.

18. The apparatus of claim 17, wherein the maximum data rate of the communication channel is a number of bits that can be received on the communication channel pet unit of time.

19. The apparatus of claim 17, wherein the required data rate of the communication channel is a number of bits that are arbitrarily required to be received in each data frame.

20. The apparatus of claim 17, wherein the apparatus is a wireless device.

21. The apparatus of claim 20, wherein the wireless device is a cellular telephone handset.

22. The apparatus of claim 17, wherein a total number of time slots in the data frame is fixed in all data frames that carry the communication channel.

23. The apparatus of claim 17, wherein the number of time slots designated to the communication channel is varied according to a change in the maximum data rate of the communication channel.

24. The apparatus of claim 17, wherein the required data rate of the communication channel is fixed.
